(19) United States
(12) Patent Application Publication
(10) Pub. No.: US 2016/0167985 A1
(43) Pub. Date: Jun. 16, 2016

(54) METHOD FOR TREATING WASTEWATER AND DEVICE FOR CARRYING OUT SAID METHOD

(71) Applicant: VM-TECSYSTEMS GMBH, Neustadt/Orla (DE)

(72) Inventor: Thomas VENIER, llmenau (DE)

(21) Appl. No.: 14/902,741

(22) PCT Filed: Jul. 1, 2014
(86) PCT No.: PCT/DE2014/000339

§ 371 Date: Jan. 4, 2016

(30) Foreign Application Priority Data
Jul. 3, 2013 (DE) 10 2013 011 395.4

(51) Int. Cl. C02F 1/461

(52) U.S. Cl. CPC C02F 1/46104; C02F 1/461; C02F 2101/20

(57) ABSTRACT

A method, for removing contaminants from wastewater includes electrolytic treatment of wastewater with the use of an anode containing materials which withstand electrolysis as well as so-called sacrificial materials which are dissolved during electrolysis, both of which are simultaneously exposed to the wastewater. An apparatus for carrying out the method includes a dimensionally stable anode cage made from platinum, titanium, niobium, palladium, ruthenium, Iridium oxide, tantalum oxide or platinized titanium, as the part of the anode that withstands electrolysis, which anode cage is provided with aluminum, iron, magnesium, calcium or mixtures of these metals as sacrificial material.

### BACKGROUND OF THE INVENTION

The invention relates to a method for wastewater treatment and to a device for carrying out this method. Both are used, in particular to remove solid particles, suspensions, and dissolved biological contaminants and compounds of heavy metals and non-ferrous metals from wastewater. The method and the device can also be used to recover raw materials from agricultural and municipal wastewater. Phosphates and ammonium compounds, for example, are intended to be selectively removed from wastewater.

A method referred to as an “advanced oxidation process” (abbreviated “AOP”) uses strong oxidants, such as ozone or hydrogen peroxide, to break down organic and inorganic substances in wastewater by means of oxidation (Wikipedia, keyword “advanced oxidation process”). With respect to the treatment of highly contaminated wastewater, however, this AOP method often does not ensure the complete purification, and therefore direct discharge into bodies of water is not possible. It is also very expensive due to the poor efficiency of the ozone generation by means of high voltage.

Electrolytic methods have proven to be more favorable in terms of the energy relationship, wherein the electrical conductivity of inorganic (ion-forming) contaminants is already sufficient. It has been proven, however, that highly contaminated, primarily organically loaded municipal wastewater also has electrical conductivity which suffices for the use of electrolytic methods.

It is known, for example, to remove organic pollutants, heavy metals, and pharmaceutical products from wastewater by means of a combination of an electrochemical AOP method, oxidative purification by means of an electrolytic method, and oxidation by ozone (German Utility Model No. 20 2009 012 539 U1). The additional use of ozone is mandatory in this case, and has the above-described economic disadvantages. The aspect of the recovery of useful materials is not taken into consideration in this technical solution.

### SUMMARY OF THE INVENTION

The object of the invention is to eliminate the above-described deficiencies of the prior art and to create a method and apparatus, which reliably ensure the removal of contaminants from wastewater with good energy efficiency, whereby the purified water can be introduced directly into bodies of water or, in special cases, can be fed to a further purification process. A further aspect of this object is to recover raw materials from agricultural and municipal wastewater or to recover raw materials from biogas plants.

The method according to the invention and the apparatus according to the invention for wastewater treatment are used, in particular, to remove organic pollutants, to separate suspensions, and remove biological contamination as well as heavy metals and non-ferrous metals in wastewater, wherein, according to the invention, a module for carrying out a method referred to henceforth as AEOP (advanced electrochemical oxidation process) is used.

An anode cage made from the materials platinum, titanium, niobium, palladium, ruthenium or platinized titanium is used in this case. This anode cage is dimensionally stable and is preferably made from expanded metal. The metal to be sacrificed is then introduced into this anode cage, it is therefore referred to as a sacrificial anode. Since this anode cage can also be filled with metals in mixed form, this anode cage also performs the function of a mixed electrode, which is novel. Metals such as magnesium and calcium can also be introduced into this mixed electrode. Ammonium and phosphate are thereby eliminated from the wastewater. The removal takes place in the form of magnesium ammonium phosphate (struvite) in this case. When the anode cage is made of iridium oxide or tantalum oxide or mixtures thereof, water having a sodium chloride content of >0.2% by mass is disinfected by means of nascent chlorine.

According to the invention, iron, aluminum, carbon, magnesium, and calcium are used as the sacrificial material. These materials can also be introduced into the anode cage in mixed form, i.e., as a mixture of two or more thereof.

The above-described method can also be combined with membrane technologies. This has the advantage that biofouling can be avoided.

According to the invention, the wastewater treatment is carried out in order to remove particulate pollutants (e.g., separation of suspensions), organic constituents, heavy metals or toxic metals in general, and pharmaceutical products. This purification process is preferably applied in the form of oxidative precipitation with the use of iron, aluminum; calcium and magnesium. It can be used for a large number of applications, such as oils and greases, small and superfine dirt particles, heavy metals and toxic metals. As a result, the content of heavy metals can be reduced to the detection limit and the organic load can be reduced by up to 75%,

With this solution according to the invention, excellent quality of the purified wastewater is ensured by means of the combination of the AEOP method with at least one further known method.

The advantageous effects of the invention are presented in the following, by way of example, in combination with possible applications thereof,

The method is optimally carried out with current densities of 40 to 120 mA/cm². The voltage is preferably less than 12 V but may be 2 to 12 V and the pH value is preferably in the range of 5 to 9 and therefore covers a range from acidic, extending across neutral, to basic. Since the electrolytic conductivity that is present here depends on the ion concentration, the current density can be adjusted via the voltage, wherein the lower limit for the inter-electrode distance and, therefore, the required electrical power, is given by the fact that the formed ions, having both signs, immediately recombine if the distance is too small. In the case of organically loaded municipal wastewater having relatively low conductivity, this minimum distance is approximately 1 to 3 cm, although this usually must be selected to be larger for reasons related to flow-resistance, and in order to prevent clogging.

In the method according to the invention, disinfection by means of nascent chlorine is achieved by adding over 0.2% by mass of sodium chloride to the wastewater. In coastal regions, this can be achieved in a particularly cost-saving manner by means of a suitable addition of sea water. In terms of a further treatment in order to obtain drinking water, the remaining sodium sons are considered to be the lesser evil as compared to sodium chloride and calcium ions, but the aforementioned addition exceeds the 200 mg/l sodium ions permitted according to the drinking water ordinance by approximately a factor of 4, and therefore a method for removing these sodium ions must be considered which is less complex than the methods of combined ion exchangers known so far, which regularly must be regenerated separately.

In particular, for the treatment of primarily organically loaded wastewater, in contrast with inorganically loaded wastewater having relatively low electrical conductivity, it was surprisingly found according to the invention that, with a view to comparable final values for the purification effect, prioritizing control of the duration of treatment is more favorable than prioritizing control via the current density, in terms of overall energy usage. Reference is made in this regard to the second of the tabbies presented below (Organically Loaded Wastewater from the Food Industry). A comparison of the third row (20 s at 40 mA/cm²) with the fourth row (10 s at 60 mA/cm²) shows that a 12.5% higher overall energy usage yields a removal efficiency which is greater by only slightly more than 1%.

Membrane techniques, i.e., filtration through a membrane, such as microfiltration, ultrafiltration or nanofiltration, may be used to separate the insoluble precipitates of pollutants as a result of their inclusion in, or chemical bonding to, the anodically dissolved sacrificial materials. Separating methods other than those mentioned can also be applied for this purpose. Since a material investigation with respect to hazardous ingredients, such as heavy metal compounds, showed that the material is safe, the intended use as fertilizer can be implemented.

In the Fenton reaction, of which use may be made in the present invention, the effect of the OH radicals, which are formed on the electrolysis-resistant materials, on organic contaminants is catalytically intensified by means of iron compounds, which is to say that this functions only when iron is used as the sacrificial material. The Fenton reaction may be promoted by simultaneously exposing the wastewater to ultraviolet (“UV”) light.

Magnesium or calcium or mixtures thereof are provided as sacrificial materials in particular applications, namely in struvite precipitation, and in the case of calcium, which is a very “base” metal, in the form of calcium phosphate, it must be ensured that contact with water without any current supply does not cause a spontaneous reaction.

In terms of treating the aforementioned group of organically loaded wastewater, it has proven advantageous to add electrically conductive carbon particles, which are inert with respect to the electrolytic processes taking place, to the sacrificial material in the anode cage. These achieve a more spatially uniform current distribution and, therefore, a more uniform participation of the content of the anode cage in the desired contaminant precipitations. In order to bring about this effect, the carbon particles must not have a substantially smaller size than approximately one-fourth that of the particles of the sacrificial materials, preferably having a mean diameter that is not smaller than approximately one-fourth that of the particles of the sacrificial materials.

In an energy-saving mode of operation according to the invention, in particular for treating wastewater having high organic pollutant content, the apparatus is such that the wastewater quantity in question has a longer dwell time in the electrolysis space. In that energy-saving mode of operation, based on the respective characteristic curves of the relative change in the COD value as a function of treatment duration and as a function of current density, treatment duration and current density are set initially and/or set over the course of the treatment to favor duration of treatment. The resulting longer time in the electrolysis space would be achievable with extremely low flow rates, which however would have the disadvantage of clogging risks, or the risk of the precipitates solidifying within the sacrificial material. An elongate tubular reactor according to the invention provides assistance here, the length of which can be varied within wide limits depending on the desired throughput and the flow rate. In particular, the anode cage is disposed by means of spacers in a tubular reactor coaxially therewith, and the wall of the tubular reactor is the anode or is internally lined with the anode. In specific embodiments, the tubular reactor is slanted downward, in the direction of flow up to approximately 20 angular degrees with respect to horizontal and, at the lower outflow end thereof, has an upper outlet for liquid components of the treated wastewater and a lower outlet for precipitates of dissolved sacrificial materials having contaminant particles or substances bound thereto. Moreover, a tapping or swinging device may be provided to strike the tubular reactor and thereby promote, by vibrations thereby created, transport of the precipitates toward the lower outlet.

The invention is described in greater detail hereafter with reference to exemplary embodiments and the associated drawings.

### BRIEF DESCRIPTION OF THE DRAWINGS

FIG. 1: is a process diagram of a process of the invention;

FIG. 2: shows an AEOP reactor of the invention;

FIG. 3: is a side view of an anode cage of the invention;

FIG. 4: is a cross section of a schematic depiction of a tubular reactor of the invention; and

FIG. 5: shows a partially cutaway, longitudinal view of a schematic representation of a tubular reactor of the invention.

### DETAILED DESCRIPTION OF THE INVENTION

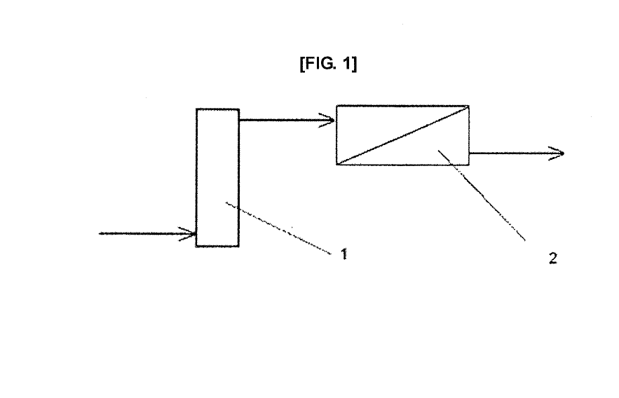

The process diagram according to FIG. 1 shows an AEOP precipitation reactor 1 followed by a filter unit 2, wherein the filter unit can be a chamber filter press or an automatic filter.

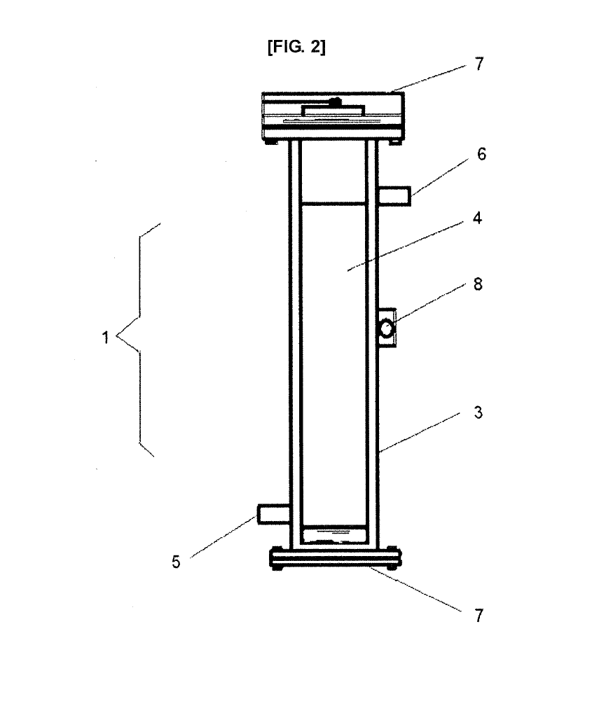

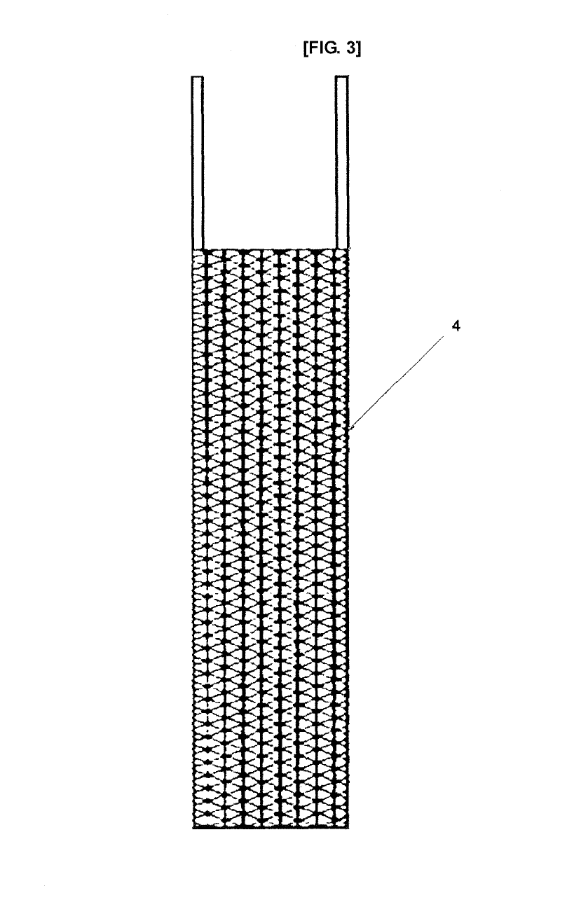

FIG. 2 schematically illustrates the design of the AEOP reactor 1 according to the invention. In general, this has the shape of a tube 3, which is closed at both ends by covers 7 and which accommodates the anode cage 4, which is merely indicated here but is shown in greater detail in FIG. 3. Any other geometric shape can also be selected for the AEOP reactor. The wastewater to be purified is Introduced at an inflow (inlet) 5 and the treated wastewater is removed at an outflow (outlet) 8. The entirety of the tube 3, except for the end-face covers 7, is at cathode potential, as it electrically is connected at the cathode connection 8. It is ensured, by means of, insulating spacers, that metallic contact does not occur between the tube 3 and the anode cage 4 in the interior of the tube 3, and therefore the wastewater flowing therebetween is subjected to electrolytic treatment, which is essential to the invention.

FIG. 3 shows a side view of the dimensionally stable anode cage 4. It is also possible to select any geometric shape, although the geometric shape must be matched to the shape of the reactor vessel. As described above, the expanded metal that is used consists of platinum, titanium, niobium, palladium, ruthenium, or platinized titanium. The sacrificial material, which is not mentioned separately here, but which is described above in detail, is located in the interior of the anode cage 4.

The efficacy of the method according to the invention is verified by means of experimental measured values in the tables provided hereinbelow, showing the resulting direct dependence of the purification effect on the current density and on the treatment time.

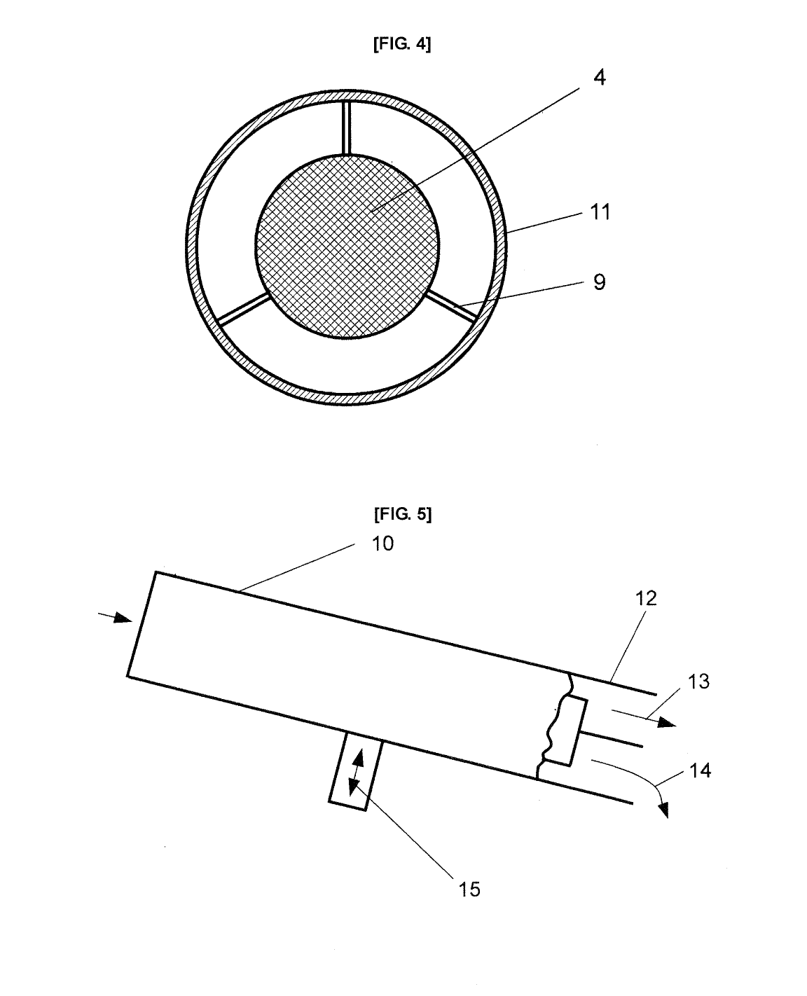

FIGS. 4 and 5 show a tubular reactor 10. The cross section of FIG. 4 shows how the anode cage 4 is held by electrically Insulating spacers 9 so as to be centered therein. This anode cage 4 extends in the longitudinal direction, as indicated in FIG. 5, along the entire length of the tubular reactor 10, with the exception of the right end thereof, which is shown in a cutaway view. The wall 11 of the tubular reactor 10 is either itself at cathode potential or this wall is designed to be electrically insulating and is coated on the inside with the cathode material. The wastewater to be treated flows in the intermediate space between the anode cage 4 and the wall 11 and naturally also penetrates the anode cage 4 as intended for the anodic treatment, it is understood that the spacers 9 must be designed to be hydrodynamically efficient.

The further embodiment of this aspect of the invention is now described with reference to FIG. 5. In the tubular reactor 10, which is tilted by 9° with respect to the horizontal in this case, wastewater to be treated is introduced from the left and is electrolytically treated in the above-described manner, such that the precipitates of dissolved sacrificial anode material, to which contaminant portions or substances are bound, concentrate in the lower part, provided the flow rate has been selected accordingly. Water, which has been purified accordingly, can now be removed at the right outflow end 12 of the tubular reactor 10, at an upper outlet 13, and concentrated precipitates can be removed at a lower outlet 14, in both cases for further treatment. The outflow of these precipitates, which have concentrated in the lower region of the tubular reactor 10, can be helped by means of a tapping or swinging device 15 mounted there on the outside.

1. Organically Loaded Wastewater (Municipal Wastewater)

| Initial | Final COD | Treatment | Current |
|---|---|---|---|
| COD Value | Value | time | Density |
| 820 mg/l | 155 mg/l | 10 sec | 40 mA/cm2 |
| 820 mg/l | 125 mg/l | 10 sec | 60 mA/cm2 |
| 820 mg/l | 95 mg/l | 10 sec | 80 mA/cm2 |
| 820 mg/l | 75 mg/l | 10 sec | 100 mA/cm2 |

2. Organically Loaded Wastewater (Food Industry)

| Initial | Final COD | Treatment | Current |
|---|---|---|---|
| COD Value | Value | Time | Density |
| 2220 mg/l | 1430 mg/l | 10 sec | 40 mA/cm2 |
| 2220 mg/l | 1330 mg/l | 15 sec | 40 mA/cm2 |
| 2220 mg/l | 1300 mg/l | 20 sec | 40 mA/cm2 |
| 2220 mg/l | 1280 mg/l | 10 sec | 60 mA/cm2 |
| 2220 mg/l | 1050 mg/l | 10 sec | 80 mA/cm2 |
| 2220 mg/l | 890 mg/l | 10 sec | 100 mA/cm2 |

3. Inorganically Loaded Wastewater (Lead Industry)

| Initial | Final | Treatment | Current |
|---|---|---|---|
| Pb Value | Pb Value | Time | Density |
| 15.2 mg/l | 0.06 mg/l | 10 sec | 40 mA/cm2 |
| 15.2 mg/l | <detection limit | 10 sec | 60 mA/cm2 |
| 15.2 mg/l | <detection limit | 10 sec | 80 mA/cm2 |
| 15.2 mg/l | <detection limit | 10 sec | 100 mA/cm2 |

4. Inorganically Loaded Wastewater (Arsenic)

| Initial | Final | Treatment | Current |
|---|---|---|---|
| As Value | As Value | Time | Density |
| 0.2 mg/l | 0.01 mg/l | 10 sec | 40 mA/cm2 |
| 0.2 mg/l | <detection limit | 10 sec | 60 mA/cm2 |
| 0.2 mg/l | <detection limit | 10 sec | 80 mA/cm2 |
| 0.2 mg/l | <detection limit | 10 sec | 100 mA/cm2 |

5. Inorganically Loaded Wastewater (Nickel)

| Initial | Final | Treatment | Current | |
|---|---|---|---|---|
| Ni Value | Ni Value | Time | Density | |
| 2.0 mg/l | 0.02 mg/l | 10 sec | 40 | mA/cm2 |
| 2.0 mg/l | <detection limit | 10 sec | 60 | mA/cm2 |
| 2.0 mg/l | <detection limit | 10 sec | 80 | mA/cm2 |
| 2.0 mg/l | <detection limit | 10 sec | 100 | mA/ |

1. A method for treating wastewater to remove heavy metals, organic pollutants, pharmaceutical product and other contaminants from wastewater, comprising electrolytically treating the wastewater with the use of an anode comprising a material which withstands electrolysis as well as a sacrificial material which is dissolved during electrolysis, wherein both the material which withstands electrolysis and the sacrificial material are simultaneously exposed to the wastewater and wherein the electrolytic treatment is carried out with the wastewater in a pH value range of 5 to 9, at a voltage less than 12 V.

2. (canceled)

3. (canceled)

4. The method according to claim 1, wherein the wastewater has an organic pollutant content indicated by an elevated COD value, and wherein based on the respective characteristic curves of relative change in the COD value as a formation of duration of said treatment and as a function of current density of said treatment, the treatment duration and current density are set initially and/or over the course of said treatment to favor duration of the treatment and thereby effect energy-saving.

5. (canceled)

6. The method according to claim 1, further comprising also treating the wastewater with ultraviolet enhanced Fenton reaction.

7. An apparatus for carrying out the method according to claim 1, wherein the material which withstands electrolysis is in a form of a dimensionally stable anode cage consisting of niobium, palladium, ruthenium, iridium oxide, or tantalum oxide or a mixture of any two or more thereof.

8. The device apparatus according to claim 7, wherein the anode cage consists of expanded metal.

9. The device apparatus according to claim 7, wherein the anode cage contains magnesium or calcium or a mixture thereof, and with aluminum or iron as the sacrificial material.

10. The device apparatus according to claim 7, further comprising carbon particles, as an electrically conductive phase, in the anode cage.

11. The apparatus according to claim 7, wherein anode cage is disposed, by means of spacers, in and coaxially with a tubular reactor, and wherein a wall of the reactor is a cathode or is internally lined a cathode.

12. The apparatus according to claim 11, wherein the tubular reactor is slanted downward, in a direction in which the wastewater is to flow therethrough, of by up to approximately 20 angular degrees with respect to horizontal and a lower, outflow end thereof has an upper outlet for liquid components of the treated wastewater and a lower outlet for precipitates of dissolved sacrificial materials having contaminant particles or substances bound thereto.

13. The apparatus according to claim 12, further comprising, mounted on the outside of the tubular reactor, a device configured to repeatedly strike a wall of the tubular reactor thereby to assist transport of the precipitates toward the lower outlet.

14. The apparatus according to claim 10, wherein the sacrificial material is comprised of particles and the carbon particles are of a mean size not smaller than one-fourth mean size of the sacrificial material particles.
